(19) United States
(12) Patent Application Publication
(10) Pub. No.: US 2014/0035396 A1
(43) Pub. Date: Feb. 6, 2014

(54) SELF-RECIPROCATING ELECTRIC MOTOR

(71) Applicant: NICHOLAS TERENCE DIGMAN, Ankeny, IA (US)

(72) Inventor: NICHOLAS TERENCE DIGMAN, Ankeny, IA (US)

(21) Appl. No.: 13/646,833

(22) Filed: Oct. 8, 2012

Related U.S. Application Data
(60) Provisional application No. 61/742,262, filed on Aug. 6, 2012.

(51) Int. Cl. H02K 33/00; H02K 53/00

(52) U.S. Cl. 310/15; 74/DIG. 9

(57) ABSTRACT

A motor that is distinct in that it is electric and it reciprocates it's own use, exemplifying more power than what is needed in function. Such a motor as to be used in torque to transmission of motion leverage, as well as power generation. A motor in which, of the properties of, and/or specifically, magnesium and steel of a non-conductive and non-grounding nature, pass one another in rotation of the motor, and in unison with other contingent and congruent assemblies, produce the electrical current to run itself and relative and/or adjoining systems. A motor of all likewise compositional equivalent in the confines of polarity friction, in by where it produces electricity and runs on it's own accord, of, and for the purpose of, working power. Portent to being, electricity is transferred to load.

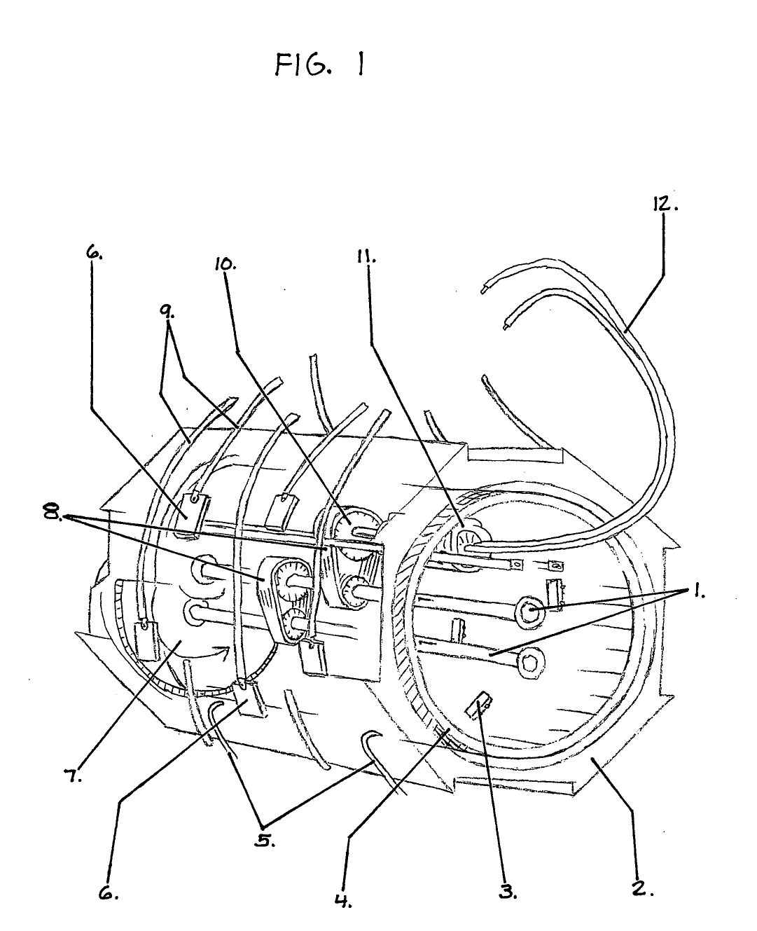

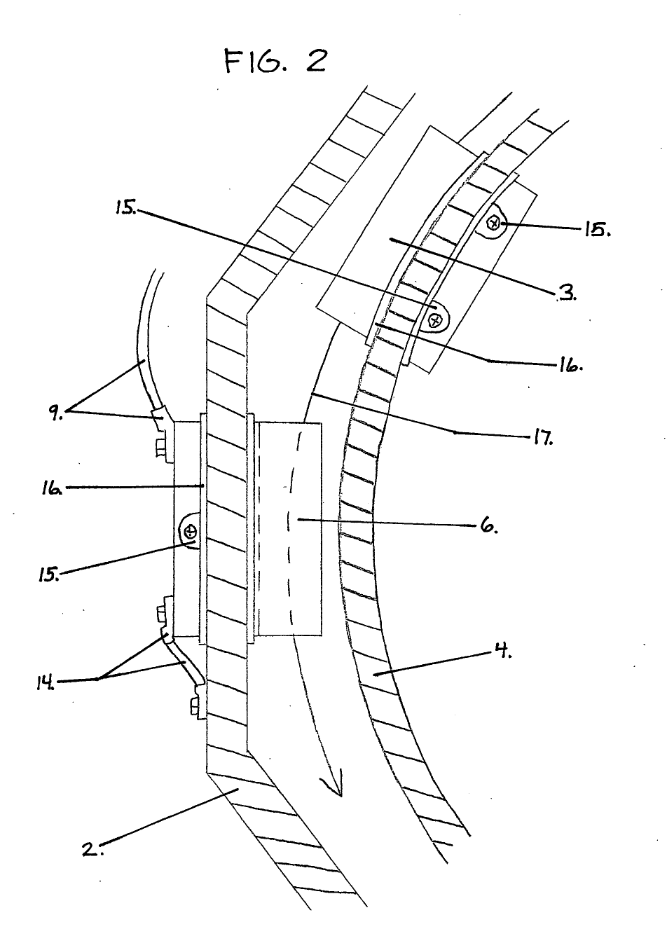

### CROSS REFERENCE TO RELATED APPLICATIONS

This Utility patent application is a continuation and result of the Provisional Patent Application of the same title, Application No. 61/742,262 filed on Aug. 6, 2012.

### SPECIFICATION

A self-reciprocating electric motor by where an electric motor placed inside, or mounted to, a block with a rotating barrel within, by where said, and complete, motor produces more output of electricity than it requires for function. A said motor, as described, by where, specifically, flat iron steel, or it's compositional equivalent, synchronized receptors on said block, coincide with, specifically, magnesium, or it's compositional equivalent, inductors on an inner aluminum, or in heavier or lighter applications, respectively, rubber or plastic, barrel that spins and in contact of polarity friction, produces, as stated in function, electricity. A said motor that may be used in direct, or indirect, drive leverage, torque, or simple power generation. A motor as wired to dampen electrical output to coincide with required electrical input.

### BACKGROUND OF THE INVENTION

1. Technical Field of the Invention

This innovation, this technology, this invention, is in purpose, for the future of mankind, applicable to nearly all industry, Such a technology as a self-reciprocating electric motor may be used as the power apparatus in direct drive, and for the use of excess power produced, in machine and application, from airplanes, boats, and automobiles, to power tools, and semi-trucks, as well as the use of electrical power generation. Anywhere there is a need of power, to torque, transmission and the need to operate appliance, or machinery, there is a demand for this invention.

2. Prior Art

There is a continuing problem in global society. The operability of modern convenience in fact, as almost, necessity to function with the expanse of population. There has been a quest, as most would see it, a revolution, of machinery and industrialization, as all inherently perplex themselves to find use and purpose with the elements that have been provided us.

Most recently in human existence, there is an endeavor to simplify, and sustain, a calling, a passion, a drive, a definite need to evolve from the need of use, and the inevitability of running out, the resources of the world.

To date, them is a quest for the use of such natural resources as natural gas, hydrogen, wind power, solar, and biological fuels, among others, trying to save what has, by many scholars, been deemed a factual conclusion. The earth is in decay, species are going instinct, and there may be an end to our existence, in the event that we do not find an answer to the perplexities of how we may co exist on the planet and maintain a standard of living.

As of right now, it is proven that there is not a technology to the equivalent of such an electric motor Apparent to all aspect, and all distant, and privileged authority, proven is fact of all social focus. From a vast array of charity, to the seat and standing of the Nation's President, and all of population in between, it is presently stated that there is a dire need of energy independence, which would be beneficial to all nations, and to a persistence in light of science, we need an environmental sustainability.

The pursuit of varied industry is evident to date. The hope and drive of the electric car company, to the invention of alternative types of combustion engines, and the advent of the hybrid, gasoline electric combinations, all with lackluster sales and marketability, a self-reciprocating electric motor, or any self-reciprocating motor, for that fact, has yet to be proven. There is a push to the creation of an environment of independence, in what we commit to, and a deep seeded social imperative to be self-sufficient.

With inspired deliberation and diligent investigation of prior focus and success in the relation of finding a better answer, there is no comparison. The combustion engine may be out of date. Solar takes great expanses. Power grids are overloaded and deteriorating. In this application by the knowledge acquired through success in chemistry, maintained common sense, having excelled in mechanical reasoning, and the sustained perseverance of physics, you will find the reasoning and acquired fact of success in workability. Such a technology, by anyone else, has yet to be proven.

### SUMMARY OF THE INVENTION

The purpose of this invention is to provide a working power to industries that utilize motors or generators, as well as to many who may be on the power grid. This invention exceeds the requirements of producing torque and the transmission to drive, as well as the contingent aspiration of exceeding consumption of energy in reciprocated use and the aspiration of fact of energy to spare. To produce self-sufficient mechanical drive is the effort, or at least focus, of many people, this invention will answer that problem.

### BRIEF DESCRIPTION OF THE DRAWINGS

DRAWING I. is a perspective drawing of the function of the as claimed, motor. It shows the drive motor and the receptors of the reciprocation of drive power. It shows all vital working parts.

DRAWING 2 is a drawing showing the mechanics of operation of the, as claimed, motor, by where Magnesium blocks pass through grounded flat iron steel blocks, as specific, barring any further advancement in relation as specific to claimed and described function, chemical, or otherwise, compositional equivalent.

### DETAILED DESCRIPTION OF THE PREFERRED EMBODIMENTS

The DRAWINGS, as prescribed, delineating the function of a Self-Reciprocating Electric Motor, are as hereby described:

As it appears on the drawings;

DRAWING 1

A, specific to application, electric motor 11 mounted by bracket, internal or external, to an aluminum block 2, whereby a barrel 4 made of aluminum, rubber, or plastic, engaged by spindle, and/or gearing, spins in the effort to reciprocate the use of said self-reciprocating electric motor.

Flat iron Steel, or the equivalent, receptors 6 are mounted, in needed timing, to the motor block 2 and are wired to a standard junction box, whereby electrical current returns to the motor, through return wires 12, running the drive motor 11. Magnesium, or the equivalent, blocks 3 pass through the U-shaped receptor blocks 6 creating the current that runs through wires 9, which in turn runs the drive motor 11.

Gears 10 run by the drive motor 11 turn and compound the force of the drive motor 11 turning the drive shafts 1, which in turn transfers all of the working power, and operates the barrel 4 that reciprocates the whole system.

Also depicted, multi-link chain 8 turns by the power exuberated, transferring the power through the drive shafts 1 to the flywheel 7 which transfers the power to transmission. This is, as described, the system of torque applied. Ground wires 5 keep to fact, and ensure, the whole system is grounded.

DRAWING 2

Depleted in this drawing is a cross section of the aluminum block 2 and the inner barrel 4. Shown is a flat iron steel, U-shaped block 6 that is grounded to the motor's block 2 by a grounding wire and standard brackets 14. The lead wire(s) 9, and adjoining bracket(s) depleted, transfer the power to be returned back into the system by means of a standard junction box. The wires and their brackets (depicted by 14 and 9) must be coated with rubber to dampen moisture infiltration.

Rubber inset boot(s) 16 must be used to keep moisture from penetrating the system, and shown are typical screws and brackets 15, which hold the polarity, and are typical to secure the fiat iron steel and Magnesium blocks, 6 and 3, in place.

The mechanics of the described motor is that that Magnesium block(s) 3 pass through, in motion depicted in rotation 17, Flat iron Steel block(s) 6, creating a pulse. And when in combination, create a steady current that exceeds the leverage exerted, operating the entire motor system.

It is hereby claimed:

1. A self-reciprocating electric motor, in by where more electrical output is created than what is needed in function.

2. A self-reciprocating electric motor, in by where the polar opposites of Magnesium and steel, and all known, or yet to be developed equivalents, pass one another in the function of a barrel spinning internal of said motor, creating a polarity friction, resulting in electricity.

3. A self-reciprocating electric motor, in by where rotation is compounded through gearing, providing a higher RPM output ratio of transmission and generating elements than the core torque and leverage delivery components.
